(19) United States
(12) Patent Application Publication
(10) Pub. No.: US 2013/0206001 A1
(43) Pub. Date: Aug. 15, 2013

(54) METHOD TO CONTROL THE LINE DISTORATION OF A SYSTEM OF POWER SUPPLIES OF ELECTROSTATIC PRECIPITATORS

(71) Applicants: Per Ranstad, Vaxjo (SE); Jörgen Linner, Vaxjo (SE)

(72) Inventors: Per Ranstad, Vaxjo (SE); Jörgen Linner, Vaxjo (SE)

(73) Assignee: ALSTOM TECHNOLOGY LTD, Baden, CH (CH)

(21) Appl. No.: 13/701,143

(22) PCT Filed: Jun. 17, 2011
(86) PCT No.: PCT/EP2011/060136

§ 371 Date: Mar. 25, 2013

(30) Foreign Application Priority Data
Jun. 18, 2010 (EP) 10166579.2

(51) Int. Cl. B03C 3/68

(52) U.S. Cl. CPC B03C 3/68
USPC 95/26; 96/25

(57) ABSTRACT

The disclosure relates to an electrostatic precipitator unit with at least two individual power supplies (11) for pulsed operation of electrostatic precipitators, wherein the power supplies (11) are powered by a common feeding (1), wherein each power supply (11) comprises a control unit (23), and wherein the control units are at least indirectly connected by communication lines (32) allowing for a controlled relative scheduling of the pulsed operation of the individual power supplies (11).

### TECHNICAL FIELD

The present invention relates to an electrostatic precipitator unit with at least two individual power supplies for pulsed operation of electrostatic precipitators, wherein the power supplies are powered by a common feeding. The invention furthermore relates to methods of operation of such an electrostatic precipitator unit.

### PRIOR ART

With the increasing concern for environmental pollution, the reduction of particle emissions by using Electrostatic Precipitators (ESPs) is a highly important issue for coal fired power plants. ESPs are highly suitable dust collectors. Their design is robust and they are very reliable. Moreover, they are most efficient. Degrees of separation above 99.9% are not unusual. Since, when compared with fabric filters, their operating costs are low and the risk of damage and stoppage owing to functional disorders is considerably smaller, they are a natural choice in many cases. In an ESP, the polluted gas is conducted between electrodes connected to an ESP power supply. Usually, this is a high-voltage transformer with thyristor control on the primary side and a rectifier bridge on the secondary side. This arrangement is connected to the ordinary AC mains and thus is supplied at a frequency, which is 50 or 60 Hz. The power control is effected by varying the firing delays of the thyristors. The smaller the firing angle, i.e. the longer the conducting period, the more current supplied to the ESP and the higher the voltage between the electrodes of the ESP. Modern ESPs are divided into several bus sections for increasing the collection efficiency. Each of these bus sections has its own power supply (PS), which is controlled individually and has a typical output power range of 10-200 kW and an output voltage range of 30-150 kVDC.

Modern ESP's power supplies are often based on resonant converters in order to utilize the transformer's nonidealities and to have soft switching for a wide operation range. One exemplary power supply for ESP's is known from US 2009/0129124.

### SUMMARY OF THE INVENTION

Modern ESP's are often operated in pulsed mode. Pulsed operation of an electrostatic precipitator considerably influences the mains power quality, since it can result in high line current distortion (total harmonic distortion) and unbalanced mains phase loading. Thus, interruption and malfunction of equipment fed by a common feeding, audible noise, heating in transformers, generators and power lines, electric resonance in the mains, mechanical oscillations in generators, engines, etc. can be caused. These problems can become worse if, for example, a group of power supplies with pulsed operation are fed by a common feeding, since the pulses in different supplies can occur at the same instant. On the other hand, if the pulses in each power supply are scheduled in an optimal way it should be possible to reduce the undesirable effects in this type of operation, so that the power consumption becomes more continuous in time. At the moment, the power supply systems for ESP application do not use any strategy for pulse scheduling and not even allow to do so; therefore arbitrary current waveform at the input occurs.

This is where the present invention has its origin, proposing an new and improved electrostatic precipitator setup for the operation of at least two power supplies connected to a common feeding, said power supplies destined to provide pulsed power output for the pulsed operation of one or several ESPs operated with said power supplies.

So this invention deals with mains' energy quality optimization for a group of power supplies feeding an Electrostatic Precipitator (ESP) with pulsed operation.

The modified electrostatic precipitator device and the corresponding optimization strategy that will be presented here can be applied to any group of power supplies operating in pulsed mode. Thereby, a considerable improvement of the line current by just controlling the starting time of the different pulses can be achieved without any additional means.

The “best case” for an ESP system occurs when all supplies at full load operate feeding the ESP with continuous power, where the mains' phase currents are balanced and the relation between the average value of the power consumption and the harmonic components are at the lowest. Considering this, the main idea of this optimization is to allow to arrange the pulses in an optimal sequence, so that the group of pulsed power supplies has similar line behaviour to that which an equivalent single power supply, which operates in continuous mode, would have.

So one of the cores of the invention can be summarized as follows:

The proposed modified electrostatic precipitator unit allows to arrange the pulses of the individual power supplies in an optimal sequence by shifting the initial pulses of each power supply by a delay time with respect to one reference. The aim is essentially to provide a structure which enables to fill the gaps between the reference pulses by the pulses of the other power supplies.

Best behavior is observed when the pulses are essentially uniformly distributed within the reference pulse period and by shifting all pulses of one field by the same delay with respect to the other fields.

More specifically, the present invention relates to an electrostatic precipitator unit with at least two individual power supplies for pulsed operation of electrostatic precipitators, wherein the power supplies are powered by the a common feeding (mains).

In accordance with the present invention, each individual power supply comprises a control unit, and these individual control units are at least indirectly connected among each other by communication lines allowing for a controlled relative scheduling of the pulsed operation of the individual power supplies.

The power supplies of the unit which are powered by a common feeding can be powering at least two individual electrostatic precipitators, e.g. each being part of a different exhaust duct. In each of these ducts there may again be several bus sections powered by individual independent power supplies also powered by a common feeding.

According to another embodiment the power supplies are part of one electrostatic precipitator, typically powering different bus sections thereof or powering different modules within one bus section.

The control may be realised in the unit either in a manner such that there is communication lines between the individual control units and one control unit takes the lead and controls the relative scheduling or this control is shared between the control units forming part of individual power supplies. On the other hand it is also possible and in accordance with another preferred embodiment of the present invention, that the unit further comprises a control computer (which can be dedicated computer or which can be a computer also dealing with other tasks in the precipitator or in the power plant) connected to the communication lines and controlling the scheduling of the power supplies.

The relative scheduling of the pulsed operation of the individual power supplies can be effected in that one power supply is defined to be the reference power supply, and the initial pulses of each further power supply are shifted by controlled delays with respect to the pulses of the reference power supply so as to fill the gaps between the reference pulses by the pulses of the further power supplies. In this case the controlled delays can be determined so as to essentially uniformly distribute the pulses of the further power supplies in the pulse period of the reference power supply, wherein preferably, if the accumulated pulse width of all power supplies is smaller than the largest pulse period, the controlled delays are determined such that the gaps between all pulses are essentially identical, if the accumulated pulse width of all power supplies is equal to the largest pulse period the controlled delays are determined such that there are no gaps between all pulses, and if the accumulated pulse width of all power supplies is larger than the largest pulse period, the overlap length of all pulses is equal.

Typically the power supplies used in this context are high voltage transformer based, preferably IGBT (integrated gate bipolar transistor) based converters, preferably series loaded resonant converters allowing to have high power and high voltage, preferably said high power being in a range of 10-200 kW and/or said high voltage being in a range of 50-150 kV DC.

According to yet another preferred embodiment, the system is adapted to operate with DC pulses provided to the electrostatic precipitators having pulse widths in the range of 0.1-20 ms, and/or having pulse periods in the range of 0.5 ms-2 s, wherein preferably the pulse ratio defined as the pulse width divided by the pulse period in the range of 1-1/2000.

The electrostatic precipitator may comprise at least one bus section for pulsed operation and at least one further bus section for continuous operation.

Furthermore the unit may, in accordance with another preferred embodiment, comprise at least three power supplies, preferably at least four power supplies, most preferably at least six power supplies, preferably all of them connected and powered by a common feeding and at least indirectly connected by communication lines. In case of large precipitator units there may be up to 24 or even 36 power supplies or more which are individually controlled and scheduled with all powered by a common feeding.

Furthermore the present invention relates to an industrial application comprising an electrostatic precipitator unit as described above, e.g. a power plant, preferably a fossil fuel operated power plant, most preferably a coal operated power plant the exhaust gases of which are cleaned by the electrostatic precipitator unit. The electrostatic precipitator unit can also be used for another dust producing process such as a sinter band sieving system, a cement manufacturing process, or the like.

In addition to the above the present invention relates to a method for the operation of a unit as outlined above, wherein preferably one power supply is defined to be the reference power supply, and wherein the initial pulses of each further power supply are shifted by controlled delays with respect to the pulses of the reference power supply so as to fill the gaps between the pulses of the reference power supply by the pulses of the further power supplies, and wherein preferentially the reference power supply is the power supply of the system which has the largest pulse period.

According to a preferred embodiment of this method, the controlled delays are determined so as to essentially uniformly distribute the pulses of the further power supplies in the pulse period of the reference power supply, wherein preferably, if the accumulated pulse width of all power supplies is smaller than the largest pulse period, the controlled delays are determined such that the gaps between all pulses are essentially identical, if the accumulated pulse width of all power supplies is equal to the largest pulse period the controlled delays are determined such that there are no gaps between all pulses, and it the accumulated pulse width of all power supplies is larger than the largest pulse period, the overlap length of all pulses is equal.

Further embodiments of the invention are laid down in the dependent claims.

### BRIEF DESCRIPTION OF THE DRAWINGS

Preferred embodiments of the invention are described in the following with reference to the drawings, which are for the purpose of illustrating the present preferred embodiments of the invention and not for the purpose of limiting the same. In the drawings,

FIG. 1 shows a typical ESP installation scheme, specifically a system with several sequential bus sections driven by 24 power supplies;

FIG. 2 a) shows a schematic of a single high frequency ESP power supply, b) a schematic of a typical single phase mains frequency ESP power supply, c) a schematic of a high frequency power processing ESP power supply;

FIG. 3 schematically shows the pulsed and continuous charging method;

FIG. 4 shows a group of 3 ESP power supplies;

FIG. 5 shows the pulse train in power supply 1 (a), power supply 2 (b) and power supply 3 (c) as well as the total power drained from the power grid (d);

FIG. 6 shows for a second example in (a) an ESP power supply 1 with a pulse ratio 1/3, in (b) an ESP power supply 2 with a pulse ratio 1/5, in (c) an ESP power supply 3 with a pulse ratio 1/7 and in (d) the total power drained from the power grid;

FIG. 7 shows a setup with direct communication between individual ESP's powered by a common feeding;

FIG. 8 shows a setup with communication via a host computer between individual ESP's powered by a common feeding; and

FIG. 9 shows an optimized example 3 and the corresponding pulse train in power supply 1 (a), power supply 2 (b) and power supply 3 (c) as well as the total power drained from the power grid (d).

### DESCRIPTION OF PREFERRED EMBODIMENTS

Usually an ESP system is divided into several bus sections to improve the particulate collection efficiency. In small systems, only 2 or 3 bus sections are connected in series and in large ones, several bus sections are connected in parallel and in series. Different power supplies with different power ratings often energize the bus sections in order to optimize the collection efficiency of the single bus section.

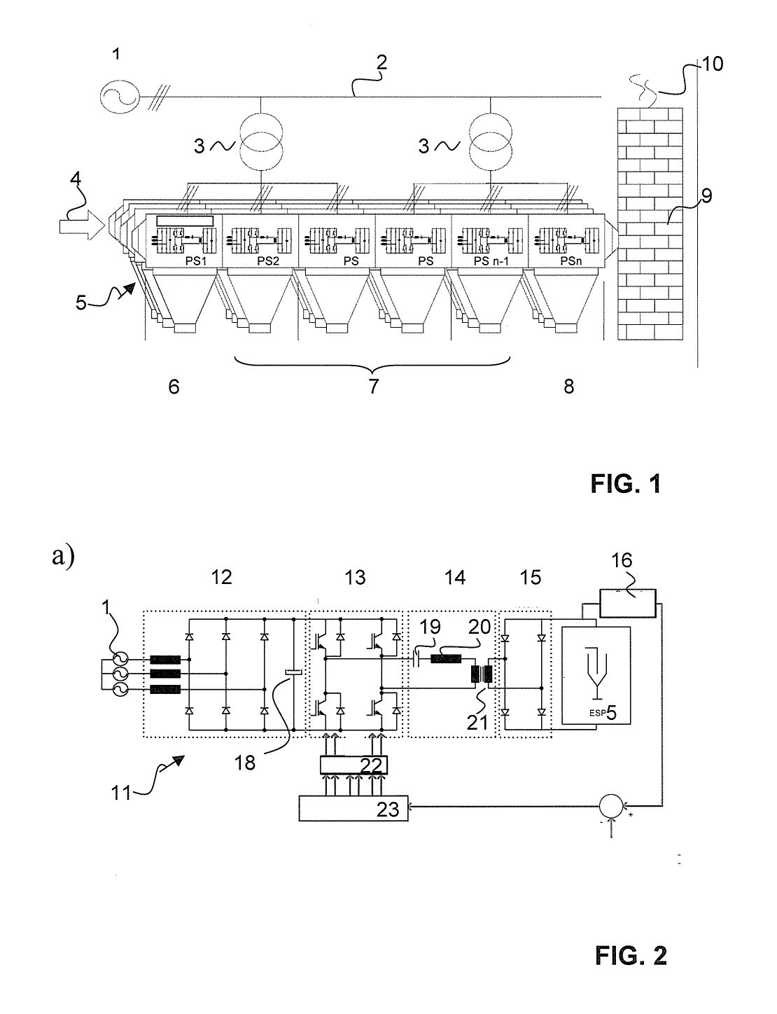

FIG. 1 shows a typical ESP installation with several sequential bus sections driven by 24 power supplies. The electrostatic precipitator 5 comprises an inlet side trough which a gas flow 4 loaded with particles, e.g. coal dust, enters the ESP. The ESP has an inlet field 6, followed by middle fields 7 and is terminating by an outlet field 8, the outlet of which is connected to a stack 9 through which the cleaned exhaust gas 10 exits to the environment. So the ESP is mechanically sectionalized in series connected fields and parallel connected cells to utilize the collection efficiency. Each field/cell position is called a bus section. One ESP power supply is feeding a single bus section with high voltage.

Each of the fields 6-8 has two rows of individually powered precipitator systems (four cells and six fields), leading to 24 bus sections, and to this end 24 power supplies (PS) are provided for the energisation of the precipitators. The general topology of such a power supply will be discussed further below. The power supplies are energized via the common feeding 1, which via a low or medium voltage line 2 and distribution transformers 3 connects to the individual power supplies. In other words the totality of the power supplies is connected to a common feeding system 1 and if these power supplies or at least a fraction thereof are operated in pulsed mode the load on the main can be heavily unbalanced.

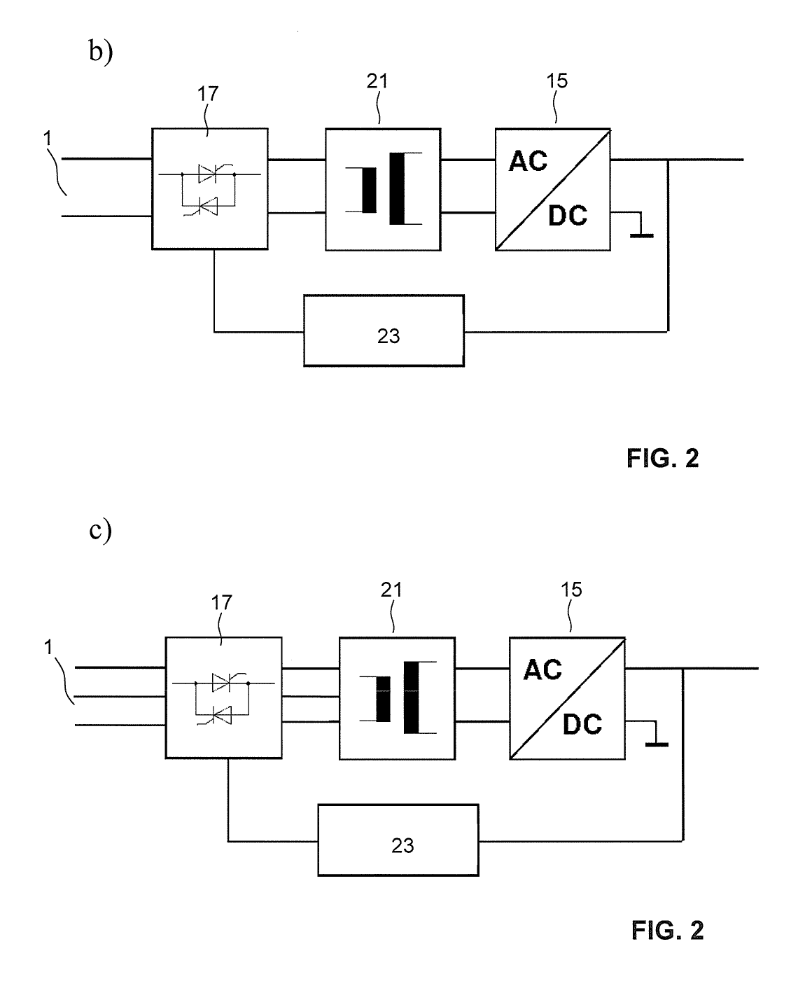

A high frequency three phase mains power supply 11 for powering one of the individual precipitators in a setup according to FIG. 1 is illustrated in FIG. 2 a. On the input side the power supply 11 is connected to the mains 1 and first comprises an input rectifier 12. At the output side of the input rectifier 12 a direct current (DC) is provided and between the levels there is located a DC link capacitor 18. This direct current is then fed trough a full bridge inverter 13 with a number of correspondingly fired transistors. The operation of the full bridge inverter 13 is controlled by drivers 22 in turn controlled by a control unit 23. The alternating current on the output side of the full bridge inverter 13 enters a resonant tank and transformer unit 14, the resonant circuit given by a series arrangement of a capacitor 19 and an inductor 20 followed by a transformer 21. On the output side the unit 14 is coupled to an output rectifier 15 the output side of which is then coupled to the electrodes of the electrostatic precipitators 5.

For pulsed operation of such a power supply the full bridge inverter is operated in pulsed mode via the control unit 23 and the drivers 22. In order to control the whole system there is provided a current and voltage sensor 16 the output of which is used for controlling the unit 23.

The present invention is not limited to high frequency three-phase power supplies as illustrated in FIG. 2a and also further schematically in FIG. 2c, which typically operate at a frequency in the resonant tank in the 20-200 kHz range. Also possible are mains frequency power processing units as illustrated in FIG. 2b, where a single phase mains 1 is switched in unit 17, transformed by a transformer 21 and rectified for the final use at the ESP after the output rectifier 15.

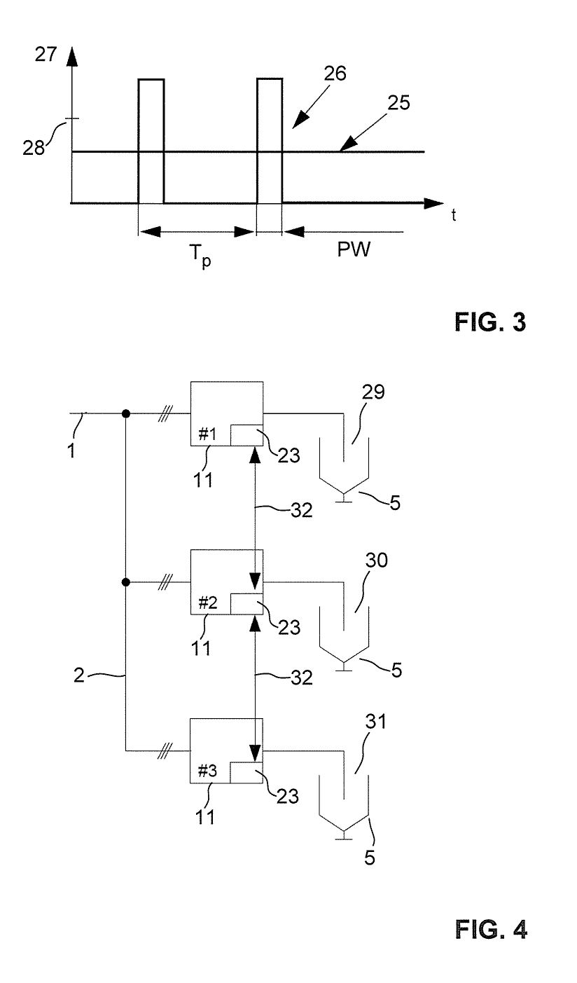

The charging method for each ESP power supply 11 can be either continuous mode 25 or pulsed mode 26 of current 27, see FIG. 3. The continuous charging method can be used in most processes where low resistivity dust is collected. The pulsed charging method is used when the dust has a medium or high resistivity or in order to save power consumption for same dust collection efficiency. Each ESP power supply is individually optimized during pulsed mode operation.

The problems occur when a group of ESP power supplies 11 are operating in pulsed charging mode and is fed by the same mains 1, as illustrated in FIG. 4. Here three individual power supplies #1, #2 and #3 are powered by the distribution line 2 by a common feeding. Each power supply drives an individual bus section 29, 30, 31, respectively, of the electrostatic precipitator 5. Generally speaking the bus sections can either be part of one single electrostatic precipitator, they may however also be parts of different electrostatic precipitators. Each of the power supplies 11 comprises an individual control unit 23 responsible for the control of the pulses via the above-mentioned full bridge inverter 13. The individual control unit 23 are interconnected via communication lines/control lines 32. In accordance with the invention of these lines 32 are used to provide for a control scheduling of the pulse trains of the individual power supplies in order to minimise distortions and in order to optimise the load on the mains.

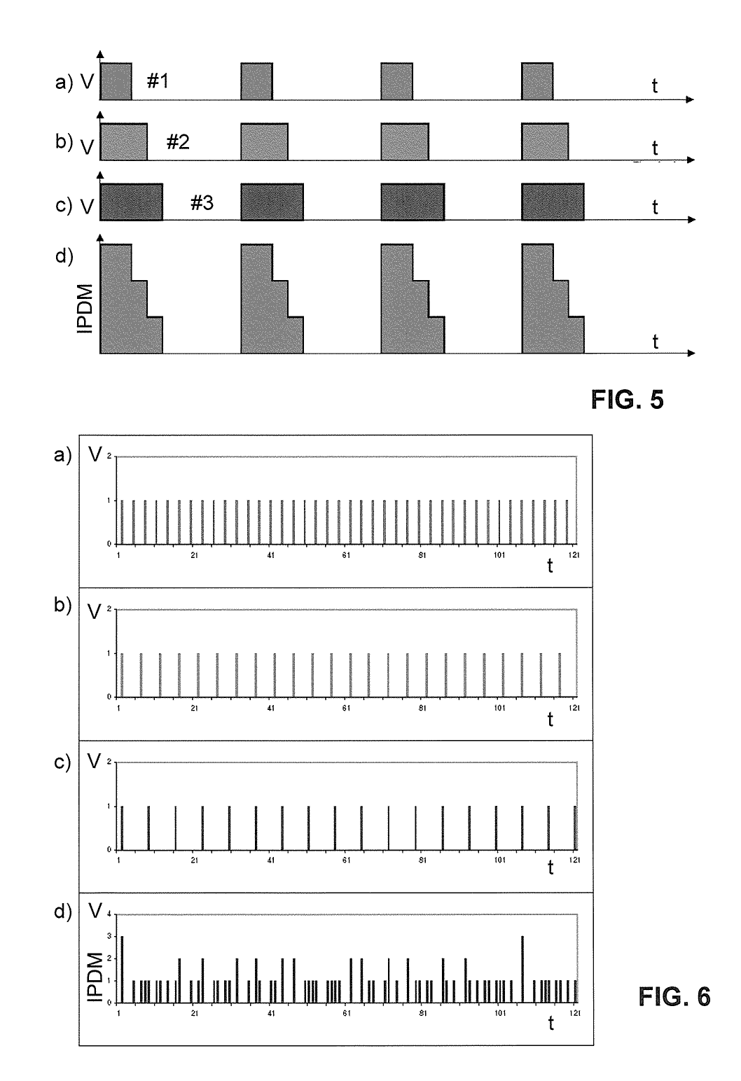

The current pulse from each ESP power supply has variable pulse width PW and variable pulse period time T_{P} as defined in FIG. 3. These parameters are optimized based on either manual or automatic tuning principles within each power supply individually. Due to that each ESP power supply controller unit 23 is individually optimizing the current pulse parameters, pulses from different ESP power supplies are however according to the state-of-the-art not coordinated and may occur at the same instant, which is illustrated in FIG. 5. The pulse period in FIG. 5 is chosen to 9 ms for all three ESP power supplies #1-#3 for simplicity, but still it is a realistic example. The pulse width is 2 ms for power supply #1, 3 ms for power supply #2 and 4 ms for power supply #3 in this first example.

The example in FIG. 5 is showing the instantaneous moment when all ESP power supplies are pulsing simultaneously, i.e. starting at the same moment in time. This leads to the repetitive pattern of the instant power drained (IPDM) from the mains as illustrated in FIG. 5 d. Normally there is a continuous drift between the ESP power supplies pulsing giving rise to a discontinuous current drained from the power grid.

The second example illustrated in FIG. 6 is showing three ESP power supplies that are pulsing with different pulse ratios. The pulse ratio is defined as the relationship between the pulse width and the pulse period. The resulting problem with pulsed mode operation of the ESP is that the line currents will show a high Total Harmonic Distortion (THD), sub-harmonics, unbalanced phase load and even a DC component in the line current. In this case, interruption and malfunction of equipment connected to the same energy system; audible noise, heating in transformers, generators and power lines; electric resonance in the mains; mechanical oscillations in generators, engines, etc. can be generated.

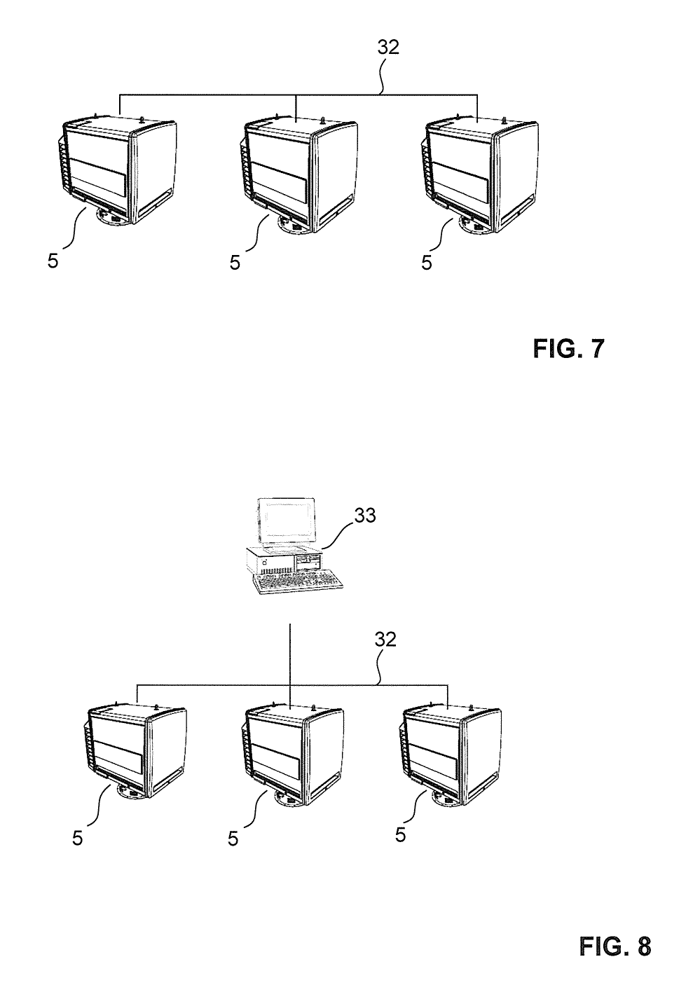

The proposed solution is that the different ESP power supplies or groups of ESP power supplies communicate as illustrated in FIG. 4 via lines 32 or as illustrated for a situation where three individual precipitators are controlled in FIG. 7. In such a way the occasions for the pulses are adjusted (scheduling) so that the power flow is as even as possible.

A different approach for the communication interface can be to use a dedicated host computer, managing the time slots for the controller unit in each local ESP power supply. FIG. 8 shows a setup where there is provided such a dedicated control computer 33 controlling the scheduling in the individual precipitators 5.

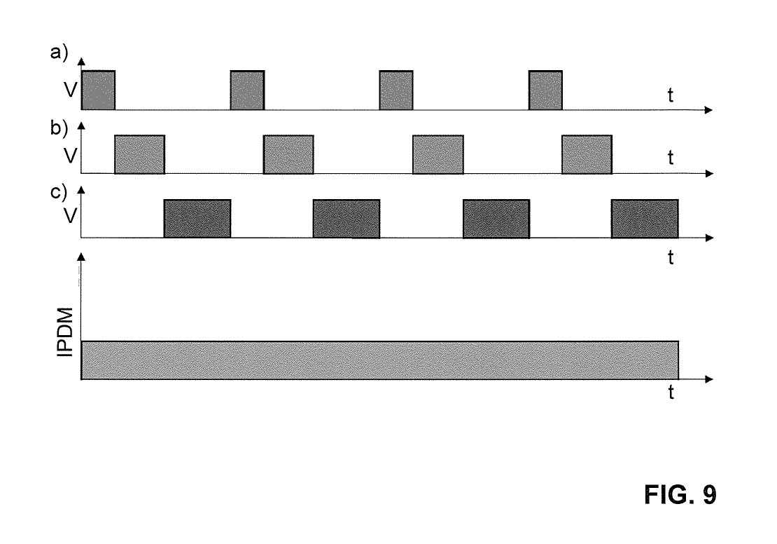

The variation in the power flow can be minimized by using a line distortion optimization algorithm in each local controller. The purpose is to limit the number of pulses from different ESP power supplies that occurs at the same instant, see FIG. 9. The pulse period in FIG. 9 is chosen to be 9 ms for all ESP power supplies for simplicity, and the pulse widths in FIGS. 9a), b), and c) are the same as described in relation with FIGS. 5a), b), and c) respectively, but still it is a realistic example. One can see that the instant power drained from the mains becomes essentially completely homogeneous over time for this particular situation where the sum of the pulse widths of the individual power supplies is equal to the pulse period.

To summarise what distinguishes the invention from existing technologies is that
there are controllers in the ESP power supplies;
there is provided means for communication between the local controllers; the controller units are exchanging information on timing for pulsing and delay in order to avoid/minimize simultaneous pulsing in different bus sections.
there is adjustment of the pulse occasions so that the line distortion is minimized. (Line distortion optimizing algorithm).

This allows to solve at least the following problems:
Possibility to meet the line distortion standards in pulsed mode operation.
Reduction of excessive losses in the grid, power cables and feeding transformers.
Reduced risk for malfunction of other equipment due to line distortion.

LIST OF REFERENCE SIGNS

| | |
|---|---|
| 1 | mains, common feeding |
| 2 | low or medium voltage level |
| | line |
| 3 | distribution transformer |
| 4 | gas flow loaded with |
| | particles, e.g. coal dust |
| 5 | electrostatic precipitator |
| 6 | inlet field |
| 7 | middle fields |
| 8 | outlet field |
| 9 | stack |
| 10 | cleaned exhaust gas |
| 11 | power supply |
| 12 | input rectifier |
| 13 | full bridge inverter |
| 14 | resonant tank and transformer |
| 15 | output rectifier |
| 16 | current and/or voltage sensor |
| 17 | thyristor blocks |
| 18 | DC link capacitor |
| 19 | capacitor in series |
| 20 | inductor in series |
| 21 | transformer |
| 22 | drivers |
| 23 | control unit |
| 25 | current for continuous |
| | operation |
| 26 | current for pulsed operation |
| 27 | secondary current |
| 28 | current limit |
| 29 | bus section 1 |
| 30 | bus section 2 |
| 31 | bus section 3 |
| 32 | communication line |
| 33 | control computer |
| t | time |
| T_{P} | pulse period, intra-pulse |
| | delay |
| PW | pulse width |
| IPDM | instant power drained from |
| | the mains |
| V | voltage |
| #1 | ESP power supply number 1 |
| #2 | ESP power supply number 2 |
| #3 | ESP power supply number 3 |

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled

14. An electrostatic precipitator unit comprising:
at least two individual power supplies for a pulsed operation of electrostatic precipitators;
a common feeding powering the power supplies; and
a control unit for each of the power supplies at least indirectly connected by communication lines for a controlled relative scheduling of the pulsed operation of the individual power supplies.

15. The electrostatic precipitator unit according to claim 14, wherein each of the power supplies power at least two individual electrostatic precipitators with each of the individual electrostatic precipitators comprising more than one independent power supply.

16. The electrostatic precipitator unit according to claim 14, wherein the power supplies are part of one electrostatic precipitator to power individual bus sections or fields thereof.

17. The electrostatic precipitator unit according to claim 14, wherein the unit further comprises a control computer connected to the communication lines of the power supplies for scheduling control.

18. The electrostatic precipitator unit according to claim 14, wherein the relative scheduling of the pulsed operation of the individual power supplies is effected by one power supply defined as a reference power supply, and initial pulses of each further power supply shifts by controlled delays to pulses of the reference power supply to fill gaps between the pulses of the reference power supply by pulses of the further power supplies.

19. The electrostatic precipitator unit according to claim 18, wherein the controlled delays are determined to uniformly distribute the pulses of the further power supplies in the gaps between pulses of the reference power supply (pulse period), and if the accumulated pulse width of all power supplies is smaller than the largest pulse period, controlled delays are set so gaps between all pulses are equal, if the accumulated pulse width of all power supplies is equal to the largest pulse period, controlled delays are set for no gaps between pulses, and if the accumulated pulse width of all power supplies is larger than the largest pulse period, controlled delays are set so overlap length of each pulse is equal.

20. The electrostatic precipitator unit according to claim 14, wherein the power supplies are single or three phase, 50 Hz or 60 Hz based power supplies, high voltage transformer based, integrated gate bipolar transistor (IGBT) based converters, series loaded resonant converters for high power and high voltage, said high power in a range of 10-200 kW or said high voltage in a range of 50-150 kV DC.

21. The electrostatic precipitator unit according to claim 14, wherein the unit operates with DC pulses provided to the electrostatic precipitators with pulse widths in the range of 0.1-20 ms, or having pulse periods in the range of 0.5 ms-2 s, wherein the pulse ratio of pulse width divided by the pulse period is 1 to 1/2000.

22. The electrostatic precipitator unit according to claim 14, wherein the electrostatic precipitator comprises at least one bus section for pulsed operation and at least one further bus section for continuous operation.

23. The electrostatic precipitator unit according to claim 14, wherein the unit comprises at least three to six power supplies, each connected and powered by a common feeding and at least indirectly connected by communication lines.

24. An industrial application, power plant, fossil fuel operated power plant, or coal operated power plant comprising:
an electrostatic precipitator unit according to claim 14 for cleaning exhaust gases from said application or plant.

25. A method of operating an electrostatic precipitator unit comprising:
defining one power supply as a reference power supply, and
shifting initial pulses of each further power supply by controlled delays from pulses of the reference power supply to fill gaps between the pulses of the reference power supply by pulses of the further power supplies,
wherein the reference power supply is the power supply of the unit with largest gaps between pulses (pulse period).

26. Method according to claim 25, wherein the controlled delays are set to uniformly distribute the pulses of the further power supplies in the pulse period of the reference power supply, and, if the accumulated pulse width of all power supplies is smaller than the largest pulse period, the controlled delays are set so gaps between pulses are equal, if the accumulated pulse width of all power supplies is equal to the largest pulse period, the controlled delays are set for no gaps between pulses, and if the accumulated pulse width of all power supplies is larger than the largest pulse period, the controlled delays are set so overlap length of each pulse is equal.
